(19) United States
(12) Patent Application Publication
(10) Pub. No.: US 2013/0276720 A1
(43) Pub. Date: Oct. 24, 2013

(54) Convertible Animal Harness

(71) Applicant: Carl B. Ferrando, New York, NY (US)

(72) Inventor: Carl B. Ferrando, New York, NY (US)

(21) Appl. No.: 13/770,054

(22) Filed: Feb. 19, 2013

Related U.S. Application Data
(60) Provisional application No. 61/637,131, filed on Apr. 23, 2012.

(51) Int. Cl. A01K 27/00

(52) U.S. Cl. CPC A01K 27/002
USPC 119/863

(57) ABSTRACT

A convertible animal harness which includes a collar and an easily attachable, removable harness. The convertible animal harness allows the animal owner to normally leave the collar on the animal with all of the animal's ID and license tags, while quickly and easily attaching the harness to control or walk the animal. The harness can then be detached when the animal owner is not walking the animal. The detachable collar closes with a buckle, and a leash may be attached. The collar can be used independently from the harness section, but the harness section cannot be used without the collar. The convertible harness attaches to the collar using a snap closure, and the harness ends are connected using Velcro. A D-ring at the back end of the harness also allows a leash to be attached.

### CROSS REFERENCE TO RELATED APPLICATION(S)

This application claims the benefit of U.S. provisional application no. 61637131, filed Apr. 23, 2012, which is incorporated by reference as if fully set forth.

### FIELD OF INVENTION

This invention relates to animal harnesses, and in particular to a convertible animal harness which includes a collar.

### BACKGROUND

As opposed to harnesses, collars for small animals or small pets encircle only the neck of the animal, and may have attached to them various ID and/or license tags for the animal. Animal owners therefore usually prefer to leave their animal's collars on at all times, so that the animal is wearing its ID and/or license tags at all times.

An animal harness generally encircles the body or torso of the animal, thereby distributing the force of the harness on the animal's body somewhat evenly. A harness has an advantage in this regard to a collar, which is more prone to cause choking of the animal than a harness. A harness may therefore be an attractive option to a animal owner for controlling or walking the owner's animal.

Many animal owners therefore may prefer to use a harness as opposed to a collar while controlling or walking their animals. Clearly, there is a need for a harness which animal owners can quickly and easily attach and detach from an animal's collar, the collar normally remaining on the animal at all times. The unique design of the present invention accomplishes this objective by allowing the animal owner the flexibility of using just a collar or optionally attaching an entire harness on the animal in addition to the collar.

### SUMMARY

The present invention, a convertible animal harness, is a unique system allowing a dog or animal owner the ability to use both a collar and an easily attachable separate harness on their animal. The convertible animal harness allows the animal owner to leave the collar on the animal at all times, with all of the animal's ID and license tags, while quickly and easily attaching the harness for walks. The harness can then be detached when the animal owner is not walking the animal, while leaving the collar on the animal.

The invention includes a detachable collar containing a buckle for closing the collar. The collar, which contains one or more D-rings for attaching a leash, can be used independently from the harness section. The harness section cannot be used on the animal without the collar in place on the animal's neck.

In one embodiment of the invention, a detachable harness attaches to the collar using a secure snap closure at the end of a longitudinal strap on the harness that passes under the collar. The secure snap closure is typically comprised of male and female components. Other embodiments of the invention may utilize a turn/lock type closure mechanism, which offers a more secure attachment of the detachable harness to the separate collar.

The detachable harness is attached to the animal's collar, and then secured around the body of the animal. Velcro straps on the ends of the detachable harness allow the width of the harness to be adjusted for the security and comfort of the animal.

The detachable harness contains one or more additional D-rings which allow a leash to be attached. Attaching the leash to the harness, instead of attaching it to the collar, prevents the animal owner from tugging on the animal's neck, which would cause discomfort to the animal.

Other features and advantages of the present invention will become apparent from the following more detailed description, taken in conjunction with the accompanying drawings, which illustrate, by way of example, the principles of the invention.

### BRIEF DESCRIPTION OF THE DRAWING(S)

FIG. 1 is a top view of the present invention including a snap closure;

FIG. 2 is a bottom view of the present invention including a snap closure;

FIG. 3 is a top view of the present invention including a turn lock closure;

FIG. 4 is a bottom view of the present invention including a turn lock closure.

### DETAILED DESCRIPTION OF ILLUSTRATIVE EMBODIMENT(S)

Many animal, dog, or pet owners prefer that their animal's ID and license tags remain on their animal at all times. Animal owners can accomplish this by leaving a collar on their animal at all times that contains all of the animal's ID and license tags. Prior to walking or controlling their animal, the animal owner may prefer to attach a harness to their animal in addition to the collar. Using a harness to walk or control the animal will usually minimize discomfort to the animal. Animal owners then usually detach the harness when the animal is not being walked or controlled. The invention described herein may be commonly utilized with dogs, but may also be utilized with a variety of four-legged animals and pets including, but not limited to rabbits, ferrets, cats, and the like.

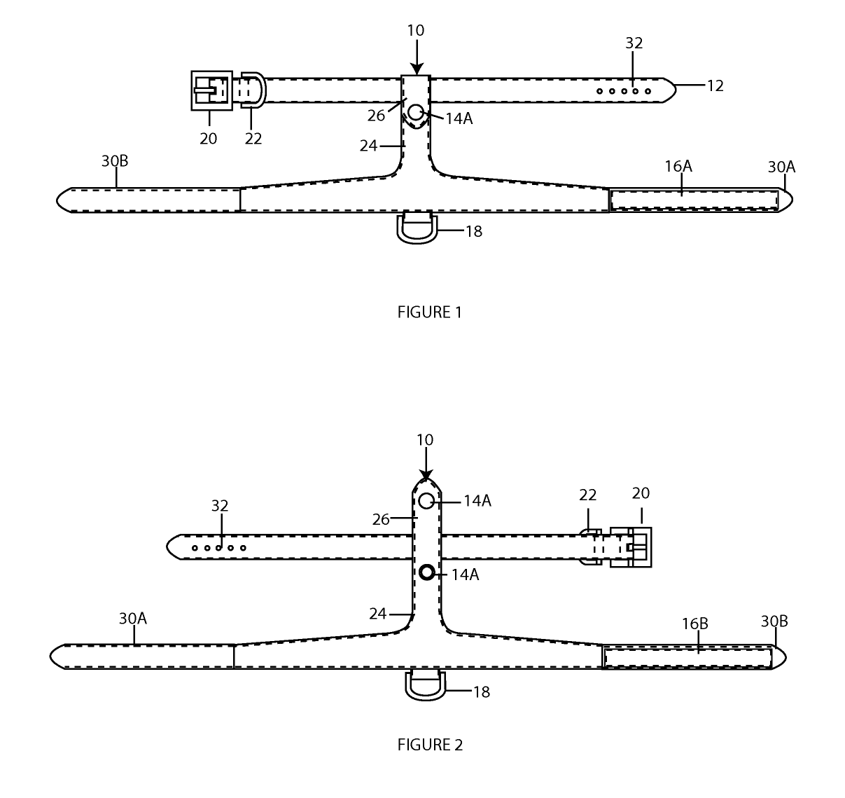

Referring now to FIG. 1, the convertible animal harness 10 including a detachable collar 12 and a detachable harness 24 is illustrated. The invention 10 is a unique system allowing the a animal owner the ability to use both the detachable collar 12 and the easily attachable separate detachable harness 24 on their dog or animal. The convertible animal harness 10 allows the animal owner to leave the detachable collar 12 on their animal at all times, with all of the animal's ID and license tags, while quickly and easily attaching the detachable harness 24 for walks or restraining the animal. The detachable harness 24 can then be detached when the animal owner is not walking or restraining the animal, while leaving the detachable collar 12 on the animal.

The detachable collar 12 extends around the neck of the animal. A longitudinal strap 26 on the detachable harness 24 is secured to the detachable collar 12. The longitudinal strap 26 of the detachable harness 24 connects to harness ends 30A,30B which pass downwardly from the longitudinal strap 26 around the body of the animal, and then connect together.

The detachable collar 12 contains one or more perforations 32 and an adjustable buckle closure 20, which connects with the perforations 32, thereby closing the detachable collar 12. The detachable collar 12, which may contain one or more D-rings 22 for attaching a leash, can be used independently from the detachable harness 24. The detachable harness 24 cannot be used on the animal without the detachable collar 12 in place on the animal's neck.

In FIG. 2 is illustrated a bottom view of the convertible animal harness 10 with the detachable harness 24 opened to illustrate how the detachable harness 24 attaches to the detachable collar 12. In FIGS. 1-2, in one embodiment of the invention, the detachable harness 24 is secured to the detachable collar 12 using a secure snap closure 14A,14B on the longitudinal strap 26 of the detachable harness 24. The secure snap closure 14A,14B is comprised of a male component 14B and a female 14A component projecting from the detachable harness 24. The female snap component 14A passes under the detachable collar 12 and closes with the male snap component 14B.

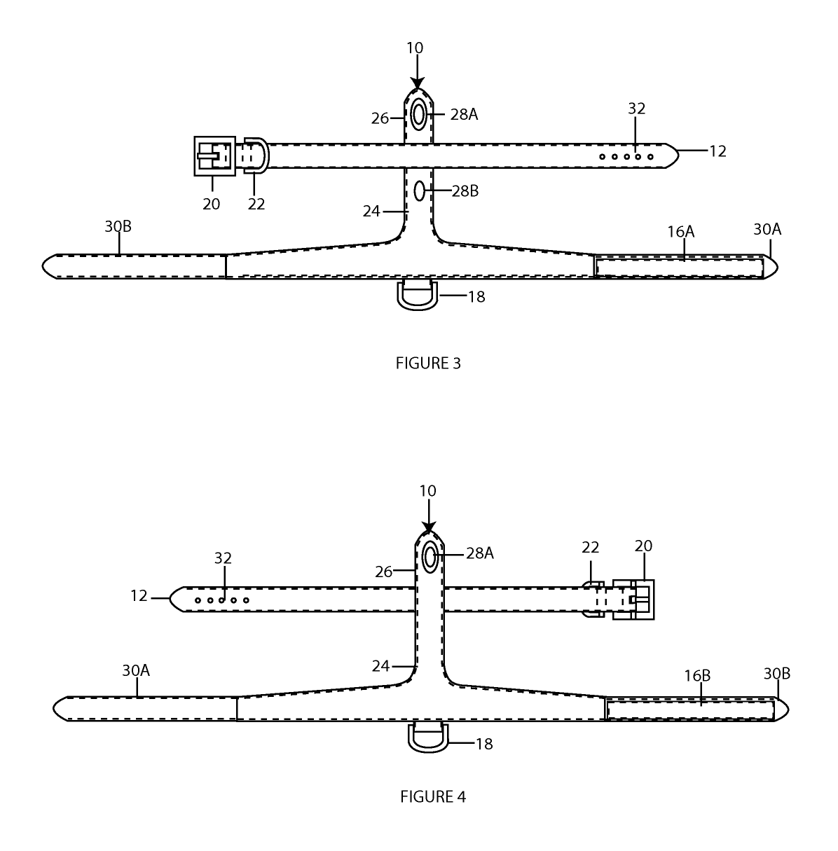

FIGS. 3-4 illustrate another embodiment of the invention 10 that may utilize a turn lock closure 28A,28B mechanism, which offers a more secure attachment of the detachable harness 24 to the detachable collar 12. FIG. 3 illustrates a top view of the convertible animal harness 10, including the turn lock opening 28A and the turn lock 28B. The turn lock closure 28A,28B offers a more secure attachment of the detachable harness 24 to the detachable collar 12 that is more appropriate for use with a larger dog. FIG. 4 illustrates a bottom view of the convertible animal harness 10, including the turn lock opening 28A and the turn lock 28B.

During use of the invention, the detachable harness 24 is attached to the detachable collar 12 using, in some embodiments, a secure snap closure 14A,14B, and in other embodiments using a turn lock closure 28A,28B. The detachable collar 12 is then secured around the neck area of the animal, with the longitudinal strap 26 extending along the body of the animal. The harness ends 30A,30B are installed around the body of the animal, and then connected together using Velcro or similar material 16A,16B. The male Velcro material 16A and the female Velcro material 16B allow the size of the detachable harness 24 to be adjusted for the security and comfort of different size animals (FIGS. 1-4).

The animal owner may attach a leash to the convertible harness 10 at one or more D-rings 18 installed along the longitudinal strap 26 or near the back of the detachable harness 24. Attaching the leash to the detachable harness 24, instead of attaching it to the detachable collar 12, prevents the animal owner from tugging on the animal's neck, which could cause discomfort or injury to the animal.

The invention 10 may be constructed of sturdy natural materials such as leather, or else man made materials, such as polyurethane. The invention 10 and its components, including the detachable collar 12 and the detachable harness 24, may be provided in a variety of sizes to accommodate different size animals. The buckle closure 20, D-rings 18,22 and closure mechanisms 14A,14B, 28A, 28B may be sewn or directly attached by any other method known in the art to the appropriate points of the invention 10.

While embodiments of the invention have been described in detail above, the invention is not limited to the specific embodiments described above, which should be considered as merely exemplary illustrations set forth for a clear understanding of the principles of the invention. Further variations, modifications, extensions, or equivalents of the invention may be developed without departing from the scope of the invention. It is therefore intended that the invention not be limited to the particular embodiments disclosed as the best mode contemplated for carrying out this invention, but that the invention will include all the embodiments falling within the scope of the appended claims.

What is claimed is:

1. A harness for an animal, the harness comprising:
a first strap configured to run longitudinally along an animal's body;
an adjustable length second strap attached to said first strap and configured to encircle the animal proximate to the animal's neck;
an adjustable length third strap attached to said first strap and configured to encircle the animal's body;
one or more securement rings attached at various points on said straps.

2. The harness of claim 1, wherein said first, second, and third straps are comprised of high tensile strength materials configured to restrain substantial sized animals.

3. The harness of claim 1, wherein said first and third straps are formed from a continuous section of material.

4. The harness of claim 1, wherein the proximal end of said first strap comprises a loop and an attachment mechanism to close said loop.

5. The harness of claim 4, wherein said attachment mechanism comprises a snap type mechanism configured to attach said first strap to said second strap.

6. The harness of claim 4, wherein said attachment mechanism comprises a turn lock type mechanism configured to attach said first strap to said second strap.

7. The harness of claim 1, wherein the proximal and distal ends of said second strap include perforations and a buckle type mechanism configured to adjust the length of said second strap.

8. The harness of claim 1, wherein the proximal and distal ends of said third strap include a velcro type connection mechanism configured to adjust the length of said third strap.

9. The harness of claim 1, wherein said securement rings comprise D-rings configured to allow an animal leash to be securely connected to the harness.

10. The harness of claim 1, wherein said adjustable length second strap is configured to be secured to the animal independently of said first and third straps.

11. The harness of claim 1, wherein said adjustable length second strap comprises a detachable collar.

12. The harness of claim 1, wherein said adjustable length third strap comprises a detachable harness.
